(19) United States
(12) Patent Application Publication
(10) Pub. No.: US 2017/0233636 A1
(43) Pub. Date: Aug. 17, 2017

(54) EMULSION OF GREEN SOLVENT AND ACID FOR SCALE REMOVAL IN IMMATURE SHALE PLAYS

(71) Applicant: SCHLUMBERGER TECHNOLOGY CORPORATION, Sugar Land, TX (US)

(72) Inventors: Kyle D. BAKE, Medford, MA (US); Andrew Emil POMERANTZ, Lexington, MA (US); George WATERS, Oklahoma City, OK (US); Syed Afaq ALI, Sugar Land, TX (US); Jason BAIHLY, Katy, TX (US)

(21) Appl. No.: 15/041,889

(22) Filed: Feb. 11, 2016

(51) Int. Cl. C09K 8/528; C09K 8/524; C09K 8/54

(52) U.S. Cl. CPC C09K 8/528; C09K 8/54; C09K 8/524; C09K 2208/32

(57) ABSTRACT

Compositions may include an aqueous phase comprising an acid source; an oleaginous phase containing an oleaginous base fluid, a pyrrolidone solvent, a terpene solvent, and a cycloalkyl ketone; and a surfactant. Methods may include emplacing a fluid in a subsurface formation, the fluid containing an aqueous phase comprising an acid source; an oleaginous phase containing an oleaginous base fluid, a pyrrolidone solvent, a terpene solvent, and a cycloalkyl ketone; and a surfactant. Methods may also include adding a treatment fluid to a hydrocarbon fluid being transported in a pipeline, the treatment fluid containing an aqueous phase comprising an acid source; an oleaginous phase containing an oleaginous base fluid, a pyrrolidone solvent, a terpene solvent, and a cycloalkyl ketone; and a surfactant.

During the drilling of a wellbore, various fluids are used in the well for a variety of functions. The fluids may be circulated through a drill pipe and drill bit into the wellbore, and then may subsequently flow upward through wellbore to the surface. During this circulation, a drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the formation by providing sufficient hydrostatic pressure to prevent the ingress of formation fluids into the wellbore, to cool and lubricate the drill string and bit, and/or to maximize penetration rate.

During production operations, hydrocarbons, such as oil and gas, migrate through connected pores and fractures within the subterranean formation and into the wellbore, where they travel to the surface. Depending on a number of factors such as porosity and permeability of a formation, hydrocarbons may navigate through the formation and into the wellbore. Conventional reservoirs may be relatively permeable to hydrocarbons, which may pass easily into a wellbore. However, unconventional reservoirs, such as shales or organic rich mudstones, may have smaller and less inter-connected pores and be less permeable to formation fluids. Further, unconventional and immature plays may contain viscous and relatively immobile organic and inorganic scales that can accumulate and block the flow of hydrocarbons within a formation.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, compositions in accordance with the present disclosure may include an aqueous phase comprising an acid source; an oleaginous phase containing an oleaginous base fluid, a pyrrolidone solvent, a terpene solvent, a cycloalkyl ketone; and a surfactant.

In another aspect, embodiments of the present disclosure are directed to methods that may include emplacing a fluid in a location in a subsurface formation, the fluid containing an aqueous phase comprising an acid source; an oleaginous phase containing an oleaginous base fluid, a pyrrolidone solvent, a terpene solvent, and a cycloalkyl ketone; and a surfactant.

In yet another aspect, embodiments of the present disclosure are directed to methods that may include adding a treatment fluid to a hydrocarbon fluid being transported in a pipeline, the treatment fluid containing an aqueous phase comprising an acid source; an oleaginous phase containing an oleaginous base fluid, a pyrrolidone solvent, a terpene solvent, a cycloalkyl ketone; and a surfactant.

Other aspects and advantages of the invention will be apparent from the following description and the appended claims.

### BRIEF DESCRIPTION OF DRAWINGS

FIGS. 1-3 are graphical representations of ternary plots for compositions in accordance with embodiments disclosed herein; and

FIG. 4 is a graphical representation showing the fraction of organic dissolved as a function of time for a composition in accordance with an embodiment of the present disclosure.

### DETAILED DESCRIPTION

In one aspect, the present disclosure is directed to the use of an acid/solvent emulsion to remove organic and inorganic scale. Emulsified treatment fluids in accordance with the present disclosure may be used as a treatment that removes a variety of organic and inorganic scales and impurities that may be present in a formation of reservoir naturally or generated from the interaction of wellbore chemicals with connate materials in the formation. Treatment fluids may increase the degree of organic and inorganic scale breakup through dual action of the removal of poorly soluble hydrocarbons when contacted by the solvent component of the emulsion and degradation of acid-sensitive constituents of the scale when contacted by the acidic aqueous internal phase.

Wellbore treatment fluids in accordance with the present disclosure may be formulated as a water-in-oil or oil-in-water emulsion and, in some cases, a high internal phase ratio (HIPR) emulsion in which the volume fraction of the internal phase is as high as 90 to 95 percent. In one or more embodiments, the oleaginous component of the emulsified treatment fluid may contain one or more co-solvents that dissolve organic residues and deposits such as bitumen and asphaltenes, in addition to an acid source that degrades acid-sensitive organic and inorganic scale components. In addition, combinations of co-solvents and/or other components of the treatment fluids may be selected to minimize the environmental impact of the treatment fluid while maintaining efficacy in scale removal.

In many reservoirs, hydrocarbon production is slowed or stopped by the buildup of scales and other deposits within the borehole, hydraulic fractures, rock matrix, or a reservoir pore system. Scales may contain organic fractions that include viscous or insoluble materials such as immature oil, bitumen, tar, or other heavy hydrocarbons, and may also contain inorganic fractions containing mineral deposits such as metal salts, silicates, and carbonates. In some instances, constituents of the inorganic fraction may be magnetic and may adhere to metal equipment present in the borehole.

Emulsified treatment fluids in accordance with the present disclosure may be used to increase the permeability within a subsurface formation, wellbore, and/or fracture network by removing organic and inorganic scales that may impede the movement of fluids throughout the formation, particularly in immature reservoirs such as shale, clay, organic rich mudstones, and other rock types that have a higher percentage of organic and inorganic deposits. Removal of scales may, in turn, increase hydrocarbon production and/or formation permeability when the well is transitioned to production to initiate hydrocarbon recovery. Further, emulsified treatment fluids may also inhibit the formation of unwanted scale and solid particulates, which may lead to improved permeability and fluid movement within the formation during fluid injection and pumping.

In some embodiments, treatment fluids may be pumped and/or injected into a far-wellbore zone of an organic shale formation, including intervals of the formation that are up to 100 meters (or 500 meters to 1000 meters in some instances) away from a production wellbore. By treating the far-wellbore zones of the formation with treatment fluid, scales further away from the wellbore may be dissolved and removed from the rock matrix of the formation. The use of emulsified treatment fluids may also prevent an acid source carried as an internal phase from being expended prematurely when delivered into an extended wellbore into a formation, or into a production well, which may increase the reaction of the acid with scales and other materials in the desired target region. Thus, production in distant wellbore zones may be increased and overall recovery improved.

In one or more embodiments, emulsified wellbore fluids may be injected into a subsurface formation by methods such as CT, bull heading, or injected into an open well or cased wellbore section, and may be used in combination with diverting treatments and tools to place treatments at multiple perforation intervals. In some embodiments, diversion materials such as biodegradable materials, ball sealers, soluble materials, rock salt, sand, among others, may be employed to divert the solvent mixture into multiple perforated intervals. The emulsified treatment fluid may be pumped in multiple stages. For example, a given volume of the solvent solution may be injected and then displaced through a CT, and then the CT may be moved to another perforated interval and another treatment can be injected. This process may be repeated multiple times, and may incorporate diversion materials and other additives. The emulsified treatment solution may also be energized or foamed with gasses such as N₂ and CO₂ in some embodiments.

In one or more embodiments, well preparation may be performed prior to injection of an emulsified treatment fluid. For example, well preparation may include removing artificial lift systems, removing tubing and drill strings, and the like. In some embodiments, solids present in the wellbore may be removed using coiled tubing (CT) or alternate techniques such as a snubbing unit, bull heading, or a chemical injection line. Treatment fluids may also be effective in displacing oil-based drilling muds from producing wells and mitigating contamination from residues and agglomerates from other wellbore chemicals such as pipe dope and various lubricants used to assemble drillstrings or pipeline assemblies.

Emulsified treatment fluids may be injected into the well through capillary strings that are used to spot fluids at various depths within a wellbore in some embodiments. For example, treatments may be placed at the depth of the artificial lift system, which is often a location of precipitated solids and scales. Wellbore treatments may be administered by continuous injection, injection and flowback, or injection and extended shut in times over various time periods. In some embodiments, solubility data obtained from testing scale samples or other testing techniques may be used to determine the appropriate time to shut in a particular well, or wells produced in similar formations and conditions. Testing results may also be used to refine the ratio and composition of the additives of solvent solutions in accordance with the present disclosure.

Other wellbore operations in which the treatment fluids may be used include hydraulic fracturing operations, enhanced oil recovery (EOR) operations, or remedial treatments to correct decreased production due to the accumulation of scales, sludges, or other low mobility deposits. For example, treatment fluids may be used in enhanced oil recovery (EOR) operations in which a wellbore fluid is injected through an injection wellbore and into a formation and is recovered at a production wellbore. During EOR, treatment fluids may flush out oil in the formation and facilitate movement of the oil into the production wellbore.

In some embodiments, treatment fluids may be injected into a subsurface formation and/or fracture network in order to initiate, restore, or increase hydrocarbon production and movement of formation fluids. As oil moves through the formation and into the wellbore during production and other operations, solids and viscous materials are transported through the formation with lighter oils. In some cases, the solids and viscous materials such as bitumen become deposited in pores within the formation, often into a near wellbore region, which can impede the flow of produced hydrocarbons. In order to restore or increase fluid flow rates during production, treatment fluids may be injected, and then the well may be shut in for a period of time that allows the treatment fluid to dissolve inorganic solids, bitumen and other organics. Wellbore operations may then be resumed, at which point treatment fluids may be pumped back from the production well along with the solubilized and/or degraded scales.

Treatment fluids may be injected with sufficient pressure to initiate hydraulic fracturing in one or more intervals of the target formation in some embodiments, and below fracture initiation pressure in other embodiments. Treatment fluids may also be used during horizontal well cleanout in some embodiments, and used to remove viscous deposits from perforations after fracturing operations in other embodiments. For example, treatment fluids may be employed in formation intervals that have been previously fractured to remove soluble materials and residues from prior wellbore treatments or to improve general fluid mobility.

In one or more embodiments, the treatment fluid may be used as an additive in pipelines to prevent and remedy deposition of organic deposits. For example, treatment fluids may be administered by constant or intermittent injection during pumping and transport of hydrocarbons and crude oils to increase the solubility of viscous hydrocarbon mixtures and prevent the accumulation of scales. In other embodiments, treatment fluids in accordance with the present disclosure may be used to restore artificial lift systems such as rod pumps and progressing cavity pumps that have been adversely affected by inorganic or organic scales.

In one or more embodiments, treatment fluids may be pumped into a formation at various temperatures. For example, the treatment fluid may be heated at the surface to temperatures above 150° C. and then injected into the formation. The high temperature of the treatment fluid may then dissolve and reduce the viscosity of organic scales within the formation.

Acid Sources

Treatment fluids in accordance with the present disclosure may be formulated as a water-in-oil or oil-in-water emulsion in which the aqueous phase contains one or more acid sources capable of degrading acid-sensitive organic and inorganic scale. Acid sources that may be used in accordance with embodiments of the present disclosure include organic acids such as acetic acid and formic acid, and mineral acids such as phosphoric acid, hydrochloric acid, nitric acid, hydrobromic acid, hydrofluoric acid, perchloric acid, and the like.

In one or more embodiments, the concentration of acid by volume of the aqueous component of a wellbore treatment fluid (v %) may range from a lower limit selected from 0.1 v %, 0.5 v %, 5 v %, and 10 v %, to an upper limit selected from 10 v %, 20 v %, 30%, 40 v %, and 50 v %, where any lower limit may be paired with any upper limit.

Oleaginous Solvent Formulations

In one or more embodiments, the oleaginous component of emulsified treatment fluids may contain an oleaginous base fluid and one or more co-solvents selected from one or more of pyrrolidones, terpenes, and cycloalkyl ketones. While the individual co-solvents are introduced below and various concentration ranges are contemplated, it is also envisioned that a subset of co-solvents may be used or minor variations in concentration may be utilized depending on the particular application without departing from the scope of this disclosure.

Pyrrolidones

Treatment fluids in accordance with the present disclosure may be formulated with a pyrrolidone co-solvent that may include alkyl pyrrolidones such as 1-ethyl-2-pyrrolidone, 1-propyl-2-pyrrolidone, 1-butyl-2-pyrrolidone, N-pentyl pyrrolidone, N-methyl pyrrolidone, N-octyl pyrrolidone, N-dodecyl-2-pyrrolidone, and the like, and alkenyl pyrrolidones such as N-vinyl-2-pyrrolidone. N-vinyl-3-propyl-2-pyrrolidone, N-vinyl-5-methyl-2-pyrrolidone, N-vinyl-5,5-dimethyl-2-pyrrolidone, N-vinyl-3,5-dimethyl-2-pyrrolidone, N-allyl-2-pyrrolidone, and the like.

In one or more embodiments, pyrrolidones may be added to a solvent component of a treatment fluid in accordance with the present disclosure at a percent by volume of the oleaginous solvent component of a treatment fluid that ranges from 0.5 v % to 50 v %. In some embodiments, pyrrolidones may be added at a percent by volume of the oleaginous solvent component of a treatment fluid in a range of 1 v % to 20 v %.

Terpene Solvents

Emulsified treatment fluids in accordance with the present disclosure may be formulated with one or more terpene co-solvents that may include alpha-pinene, d-limonene, 1-limonene, dipentene (also known as 1-methyl-4-(1-methylethenyl)-cyclohexene), myrcene, linalool, and mixtures thereof.

In one or more embodiments, terpenes may be added to an oleaginous solvent component of a treatment fluid in accordance with the present disclosure at a percent by volume of the solvent component of a treatment fluid that ranges from 0.5 v % to 50 v %. In some embodiments, terpenes may be added at a percent by volume of the oleaginous solvent component of a treatment fluid in a range of 1 v % to 20 v %.

Cycloalkyl Ketones

Emulsified treatment fluids in accordance with the present disclosure may be formulated with one or more cycloalkyl ketones that may include 4-t-butylcyclohexanone, 4-phenylcyclohexanone, cyclohexanone and dihydrocarvone.

In one or more embodiments, cycloalkyl ketones may be added to a solvent component of a treatment fluid in accordance with the present disclosure at a percent by volume of the oleaginous solvent component of a treatment fluid that ranges from 0.5 v % to 50 v %. In some embodiments the one or more cycloalkyl ketones may be added at a percent by volume of the oleaginous solvent component of a treatment fluid in a range of 1 v % to 10 v %.

In one or more embodiments, surfactants of the present disclosure may include a solvent blend that is mixed in ratios of pyrrolidone solvent:terpene solvent:cycloalkyl ketone in the range of 1:1:1 to 4:1:1. However, the ratio of terpene solvent to cycloalkyl ketone may vary in some embodiments, for example, the ratio of pyrrolidone solvent:terpene solvent:cycloalkyl solvent may range from X:0.25:1 to X:1:0.25, where X ranges from 0.25 to 4. In some embodiments, the ratio of pyrrolidone solvent:terpene solvent:cycloalkyl ketone may be 2:1:1.

Oleaginous Base Fluid

Treatment fluids in accordance with the present disclosure may include an oleaginous base fluid as the continuous phase of an emulsified treatment fluid. Oleaginous base fluids in accordance with the present disclosure may include aromatic solvents, kerosene, diesel fuel oils, mineral spirits, light oils, mineral oils, toluene, synthetic oils such as hydrogenated and unhydrogenated olefins, including polyalpha olefins, linear and branch olefins and the like, polydiorganosiloxanes, siloxanes, or organosiloxanes, esters of fatty acids such as straight chain, branched and cyclical alkyl esters of fatty acids. However, the above list is not exhaustive, and it is envisioned that any environmentally acceptable oleaginous solvent that is compatible with the terpene solvents and cycloalkyl ketones mentioned above could be used.

The oleaginous solvent component of a wellbore fluid in accordance with the present disclosure may contain an oleaginous base fluid at a percent by volume (v %) of the oleaginous solvent component that ranges from 5 v % to 95 v %.

Treatment fluids in accordance with the present disclosure may have an oleaginous solvent component and an aqueous component having a ratio of the aqueous component to the oleaginous component with a range of 30:70 to 95:5 in some embodiments, from 50:50 to 95:5 in some embodiments, and from 70:30 to 95:5 in yet other embodiments.

Surfactants

Treatment fluids in accordance with the present disclosure may be combined with one or more surfactants that act to stabilize the water-in-oil or oil-in-water emulsion. In one or more embodiments, surfactants in accordance with the present disclosure may be nonionic surfactants such as oxyalkylated alkylalcohols, linear and branched primary alcohol alkoxylates such as ethoxylated alcohols, propylated alcohols, and butylated alcohols, secondary alcohol alkoxylates, fatty alcohol alkoxylates, alkoxylated fatty acids, fatty acid ester soaps, alkylphenol ethers, alkyl phosphates, silicone glycol copolymers, phosphate esters, glucosides such as cetearyl glucoside, alkyl polyglucosides, and alkoxylated triglycerides, and mixtures thereof. Surfactants in accordance with the present disclosure may also include ethylene oxide polymers, copolymers and block copolymers of poly(ethylene oxide-propylene oxide) (PEO-PPO) with different ethylene oxide (EO) to propylene oxide (PO) molar ratios, and poloxamers. Further, one of ordinary skill would appreciate that this list is not exhaustive, and that other surface active agents may be used in accordance with embodiments of the present disclosure.

In one or more embodiments, surfactants may be incorporated into treatment fluids at a percent by volume of treatment fluid (v %) that ranges 0.5 v % to 3 v %.

Treatment fluids in accordance with the present disclosure may also include a corrosion inhibitor. Suitable corrosion inhibitors may include, for example, nitrogen-containing heterocyclic aromatic quaternary salts such as N-cyclohexylpyridinium bromide, N-octylpyridinium bromide, N-nonylpyridinium bromide, N-decylpyridinium bromide, N-dodecylpyridinium bromide, N,N-dodecyldipyridinium dibromide, N-tetradecylpyridinium bromide, and N-laurylpyridinium chloride, phenyl ketones, phosphonates, polydentate chelating agents such as ethylenediaminetetraacetic acid, diethyl enetriaminepentaacetic acid, nitrilotriacetic acid, ethylene glycol-bis(2-aminoethyl)-N,N,N′,N′-tetraacetic acid, 1,2-bis(o-aminophenoxy)ethane-N,N,N′,N′-tetraaceticacid, cyclohexanediaminete-traacetic acid, triethylenetetraaminehexaacetic acid, N-(2-Hydroxyethyl)ethyl enediamine-N,N′,N′-tri acetic acid, glutamic-N,N-diacetic acid, ethylene-diamine tetra-methylene sulfonic acid, diethylene-triamine penta-methylene sulfonic acid, amino tri-methylene sulfonic acid, ethylene-diamine tetra-methylene phosphonic acid, diethylene-triamine penta-methylene phosphonic acid, amino tri-methylene phosphonic acid, and mixtures thereof.

### EXAMPLES

In the following examples, various solvent chemistries and emulsified fluids in accordance with the present disclosure were formulated and assayed for their ability to dissolve scales containing organic and inorganic components.

### Example 1

### Treatment of Scales with Various Solvent Formulations

In the following example, scale isolated from a wellbore was tested with an oleaginous solvent alone and in combination with hydrochloric or hydrofluoric acids. As can be seen in Table 1, the oleaginous solvent alone removes between 20 and 80% of the scale, while leaving an inorganic residue that was also characterized in that it was magnetic. Following treatment with the oleaginous solvent, any remaining scale was dried and treated with hydrochloric or hydrofluoric acid. After filtering the acid, between 43% and 90% of the mass of the scale was removed. In addition, the acid treatments also effectively removed the magnetic character from the remaining scale.

TABLE 1
Treatment data for mixed organic/inorganic scales.

| | Solvent | | Solvent + | | Solvent + | |
|---|---|---|---|---|---|---|
| | extraction only | | HF treatment | | HCl treatment | |
| | | % | % | % | % | % |
| | | Mag- | Combined | Mag- | Combined | Mag- |
| | % | netic | removal | netic | removal | netic |
| | Organic | after | (solvent | (after | (solvent | (after |
| Sample | removed | removal | & HF) | acid) | & HF) | acid) |
| Scale 1 | 25 | 100 | 62 | 0 | 90 | 0 |
| Scale 2 | 20 | 100 | 76 | 0 | 87 | 0 |
| Scale 3 | 22 | 52 | 57 | 0 | 77 | 0 |
| Scale 4 | 44 | 100 | 72 | 0 | 85 | 0 |
| Scale 5 | 23 | 100 | 23 | 0 | 95 | 0 |
| Scale 6 | 43 | 6 | 43 | 0 | 43 | 0 |
| Scale 7 | 77 | 80 | 77 | 0 | 77 | 0 |

### Example 2

### Solvent Solution Component Selection

Once it was determined that the scale can be removed using a combination of solvent and acid treatments, steps were taken to produce a single emulsion that could be used to carry out the scale removal in the field. First, an environmentally acceptable solvent solution was identified that effectively removed the organic soluble fraction of the scale. Tests were performed to determine which solvent solution best dissolved the organic fraction of the wellbore scale, to determine at what concentration of additives the acid/solvent emulsion would be stable, and to test how effective the emulsion would be at removing the scale.

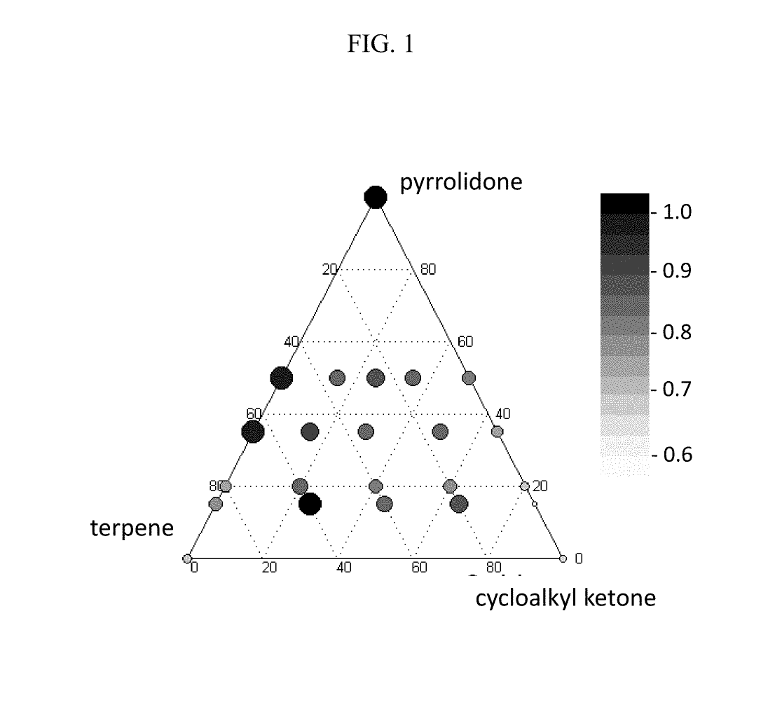

In order to identify the most effective solvent mixture, 26 different blends were produced having an oleaginous base solvent as shown in Tables 2 and 3. Each solvent solution is 90% base solvent and 10% total additive or 85% base solvent and 15% total additive. Solvent solutions were tested individually by adding 3 mL of the solvent solution to a vial containing 250 mg of the scale. These vials were then left overnight at a temperature of 80° C. The solvent solution was then decanted from the fraction of the sludge that was not dissolved, and the amount of scale dissolved by the solvent solution was measured. Tests were repeated for seven different scale samples. For each solvent, the maximum value of material dissolved was set to one and the other values were normalized as a fraction of that value. Ternary plots generated from the data are presented in FIGS. 1-3.

TABLE 2
Solvent solutions studied for scale treatment

| | | | cycloalkyl |
|---|---|---|---|
| Solution | pyrrolidone | terpene | ketone |
| Number | (v %) | (v %) | (v %) |
| 0 | 0 | 0 | 0 |
| 1 | 10 | 0 | 0 |
| 2 | 5 | 0 | 5 |
| 3 | 5 | 1.5 | 3.5 |
| 4 | 5 | 2.5 | 2.5 |
| 5 | 5 | 3.5 | 1.5 |
| 6 | 5 | 5 | 0 |
| 7 | 3.5 | 0 | 6.5 |
| 8 | 3.5 | 1.5 | 5 |
| 9 | 3.5 | 3.5 | 3 |
| 10 | 3.5 | 5 | 1.5 |
| 11 | 3.5 | 6.5 | 0 |
| 12 | 2 | 0 | 8 |
| 13 | 2 | 2 | 6 |
| 14 | 2 | 4 | 4 |
| 15 | 2 | 6 | 2 |
| 16 | 2 | 8 | 0 |
| 17 | 1.5 | 0 | 8.5 |
| 18 | 1.5 | 2 | 6.5 |
| 19 | 1.5 | 4 | 4.5 |
| 20 | 1.5 | 6 | 2.5 |
| 21 | 1.5 | 8.5 | 0 |
| 22 | 0 | 5 | 5 |
| 23 | 0 | 10 | 0 |
| 24 | 0 | 0 | 10 |
| 25 | 5 | 5 | 5 |

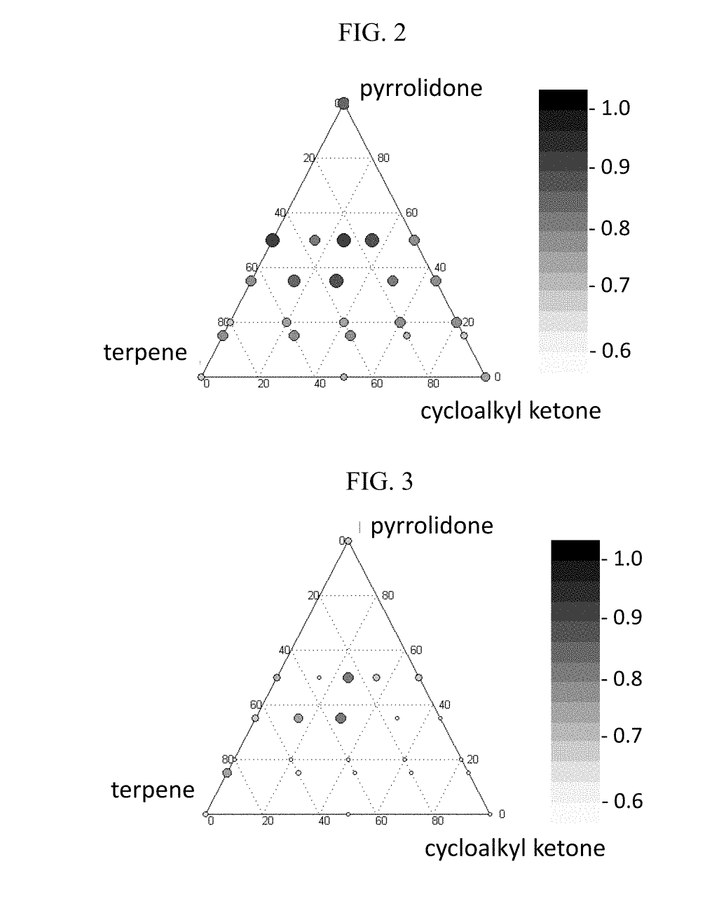

With particular respect to FIG. 1, a ternary plot of additives is shown. The size and shading of the points represents the fraction of sludge, containing mixed organic and inorganic scale, and is dissolved by the corresponding solvent solution. In order to identify a single solvent solution that would be effective for removing the organic fraction for all scales, two additional ternary plots were produced as FIGS. 2 and 3 showing average fraction dissolved over seven different scale samples, and the minimum fraction removed over seven different scale samples. From this data, solvent solution of 90% oleaginous base solvent, 5% of pyrrolidinone solvent, 2.5% terpene solvent, and 2.5% of a cycloalkyl ketone as selected for further study based on a balance of factors including effectiveness in removing scale, environmental compatibility, and cost concerns.

### Example 3

### Kinetic Test

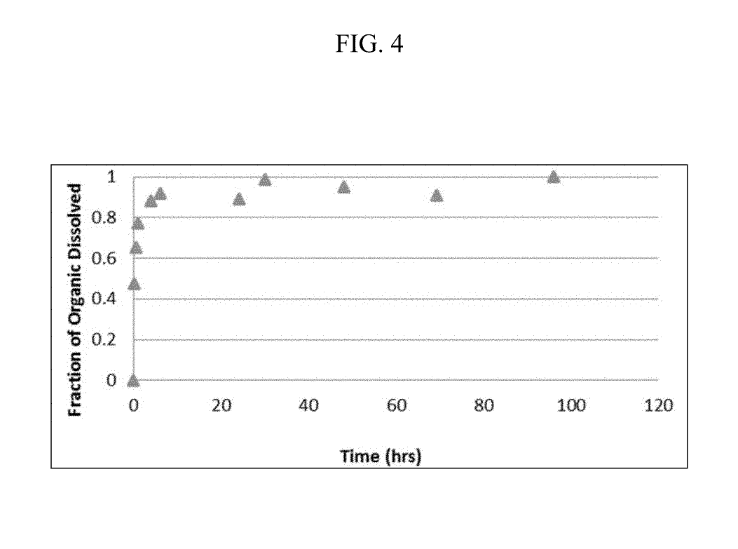

In the next example, a test to determine the length of time for the organic fraction of the scale to be dissolved by the solvent was also performed. In this test, 250 mg of scale was added to multiple vials. Into each vial was added 3 mL of solvent. The solvent was then removed from the vials at various time points, and the fraction of dissolved scale for each sample was measured. A graphical representation of the fraction of organic scale dissolved as a function of time is shown in FIG. 4, in which the solvent package dissolved a maximum amount of scale in approximately six hours. While some additional time may be required when the reaction is scaled up for treatment in a wellbore, this test provides an estimate of the time required for scale removal and may be used as a benchmark as to the time required for well shut in prior to initiating flowback.

### Example 4

### Emulsion Efficiency Test

In the next example, tests were performed to determine the efficacy of the emulsified formulations in removing and degrading scale. To test the effectiveness of emulsified formulations, a weighed sample of dried scale was placed in a vial along with test formulations of 70:30 acid to oleaginous solvent solution, 90:10 acid to oleaginous solvent solution, and water as a control. Emulsified fluids were prepared from a solution of hydrochloric acid and then combined with the respective fraction of an oleaginous solvent solution of 90% oleaginous base oil, 5% pyrrolidone solvent, 2.5% terpene solvent, and 2.5% cyclolkyl ketone. The aqueous and oleaginous solvent solutions were mixed together and combined with 1.5% surfactant and 0.2% corrosion inhibitor.

Samples were shaken and placed in an 80° C. sand bath overnight and then filtered using a 125 μm mesh filter. The isolated solids were dried, weighed, and tested for any magnetic characteristic. After treatment with the emulsified treatment fluids the scale was degraded to a fine powder and a yellow color was produced following the acid treatment, which suggests that a chemical reaction is occurring with components of the scale. The fraction of the scale removed from each of the assayed fluid formulations as well as the control experiment was recorded as shown in Table 3.

TABLE 3
Fractions of scale removed from various treatment fluids.

| | H₂O control | | 90:10 acid:solvent | | 70:30 acid:solvent | |
|---|---|---|---|---|---|---|
| | | % | | % | | % |
| | % Re- | Residue | % Re- | Residue | % Re- | Residue |
| Sample | moved | Magnetic | moved | Magnetic | moved | Magnetic |
| Scale 1 | 22 | 100 | 64 | 0 | 77 | 0 |
| Scale 4 | 13 | 65 | 72 | 0 | 72 | 0 |

The data demonstrate that it is possible to remove a majority of the sludge using the emulsified treatment formulations. The remaining scale is nonmagnetic after treatment, and it is envisioned that any small fraction of scale remaining could then be flushed out by applying a flow treatment during application in the field.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112(f) for any limitations of any of the claims herein, except for those in which the claim expressly uses the words ‘means for’ together with an associated function.

What is claimed is:

1. A composition comprising:
an aqueous phase comprising an acid source;
an oleaginous phase comprising:
an oleaginous base fluid,
a pyrrolidone solvent,
a terpene solvent, and
a cycloalkyl ketone; and
a surfactant.

2. The composition of claim 1, further comprising a corrosion inhibitor.

3. The composition of claim 1, wherein the concentration of the acid source in the aqueous phase is 5 v % to 50 v %.

4. The composition of claim 1, wherein the acid source is one or more selected from a group consisting of: acetic acid, phosphoric acid, hydrochloric acid, nitric acid, hydrobromic acid, hydrofluoric acid, and perchloric acid.

5. The composition of claim 1, wherein the pyrrolidone solvent is one or more selected from a group consisting of: 1-ethyl-2-pyrrolidone, 1-propyl-2-pyrrolidone, 1-butyl-2-pyrrolidone, N-methyl pyrrolidone, N-pentyl pyrrolidone, N-octyl pyrrolidone, N-dodecyl-2-pyrrolidone, N-vinyl-2-pyrrolidone. N-vinyl-3-propyl-2-pyrrolidone, N-vinyl-5-methyl-2-pyrrolidone, N-vinyl-5,5-dimethyl-2-pyrrolidone, N-vinyl-3,5-dimethyl-2-pyrrolidone, and N-allyl-2-pyrrolidone.

6. The composition of claim 1, wherein the cycloalkyl ketone is one or more selected from a group consisting of: 4-t-butylcyclohexanone, 4-phenylcyclohexanone, cyclohexanone, and dihydrocarvone.

7. The composition of claim 1, wherein the terpene solvent is one or more selected from a group consisting of: alpha-pinene, d-limonene, 1-limonene, dipentene, myrcene, and linalool.

8. The composition of claim 1, wherein the surfactant is present in the composition at a percent by volume of the composition that ranges from 0.5 v % to 3 v %.

9. The composition of claim 1, wherein the ratio of the aqueous phase to the oleaginous phase is within the range of 70:30 to 95:5.

10. A method comprising:
emplacing a fluid in a location in a subsurface formation, the fluid comprising:
an aqueous phase comprising an acid source;
an oleaginous phase comprising:
an oleaginous base fluid,
a pyrrolidone solvent,
a terpene solvent, and
a cycloalkyl ketone; and
a surfactant.

11. The method of claim 10, further comprising:
contacting an organic or inorganic scale present in the subsurface formation.

12. The method of claim 10, wherein emplacing the fluid in the location in the subsurface formation comprises using the fluid to remove scale from hydraulic or natural fracture networks, and/or restore an artificial lift system.

13. The method of claim 10, wherein the fluid further comprises a corrosion inhibitor.

14. The method of claim 10, further comprising:
recovering hydrocarbons from the location in the subsurface formation.

15. The method of claim 10, wherein the concentration of the acid source in the aqueous phase is 5 v % to 50 v %.

16. The method of claim 10, wherein the acid source is one or more selected from a group consisting of: acetic acid, phosphoric acid, hydrochloric acid, nitric acid, hydrobromic acid, hydrofluoric acid, and perchloric acid.

17. The method of claim 10, wherein the pyrrolidone solvent is one or more selected from a group consisting of: 1-ethyl-2-pyrrolidone, 1-propyl-2-pyrrolidone, 1-butyl -2-pyrrolidone, N-methyl pyrrolidone, N-pentyl pyrrolidone, N-octyl pyrrolidone, N-dodecyl-2-pyrrolidone, N-vinyl-2-pyrrolidone. N-vinyl-3-propyl-2-pyrrolidone, N-vinyl-5-methyl-2-pyrrolidone, N-vinyl-5,5-dimethyl-2-pyrrolidone, N-vinyl-3,5-dimethyl-2-pyrrolidone, and N-allyl-2-pyrrolidone.

18. The method of claim 10, wherein the cycloalkyl ketone is one or more selected from a group consisting of: 4-t-butylcyclohexanone, 4-phenylcyclohexanone, cyclohexanone, and dihydrocarvone.

19. The composition of claim 10, wherein the terpene solvent is one or more selected from a group consisting of: alpha-pinene, d-limonene, 1-limonene, dipentene, myrcene, and linalool.

20. A method comprising:
adding a treatment fluid to a hydrocarbon fluid being transported in a pipeline, the treatment fluid comprising:
an aqueous phase comprising an acid source;
an oleaginous phase comprising:
an oleaginous base fluid,
a pyrrolidone solvent,
a terpene solvent, and
a cycloalkyl ketone; and
a surfactant.

21. The method of claim 20, wherein the concentration of the acid source in the aqueous phase is 5 v % to 50 v %.

22. The method of claim 20, wherein the acid source is one or more selected from a group consisting of: acetic acid, phosphoric acid, hydrochloric acid, nitric acid, hydrobromic acid, hydrofluoric acid, and perchloric acid.
